(19) United States
(12) Patent Application Publication
(10) Pub. No.: US 2007/0165339 A1
(43) Pub. Date: Jul. 19, 2007

(54) Control and manipulation of pinned layer remanence of a platinum manganese based bottom spin valve

(75) Inventor: Dulip Welipitiya, Morgan Hill, CA (US)

Correspondence Address: PATTERSON & SHERIDAN, L.L.P., 3040 POST OAK BLVD., SUITE 1500, HOUSTON, TX, 77056, US

(73) Assignee: HITACHI GLOBAL STORAGE TECHNOLOGIES NETHERLAND, B.V.

(21) Appl. No.: 11/333,042

(22) Filed: Jan. 17, 2006

(51) Int. Cl. G11B 5/33; G11B 5/127

(52) U.S. Cl. 360/324.11

(57) ABSTRACT

Methods and apparatus provide a magnetic head that includes a magnetoresistive read sensor. A remanence of a pinned layer within the read sensor can be improved without substantially altering other physical or magnetic properties of the read sensor. Changing a sputtering gas flow rate during deposition of an antiferromagnetic layer within the read sensor can lower the remanence of the pinned layer and hence a remanence of the read sensor.

### BACKGROUND OF THE INVENTION

1. Field of the Invention

Embodiments of the invention generally relate to electronic data storage and retrieval systems having magnetic heads capable of reading recorded information stored on magnetic media.

2. Description of the Related Art

In an electronic data storage and retrieval system, a magnetic head typically includes a reader portion having a magnetoresistive (MR) sensor for retrieving magnetically-encoded information stored on a magnetic recording medium or disk. The MR sensor includes multiple layers and operates based on a change of electrical resistance of certain materials of the MR sensor in the presence of a magnetic field. During a read operation, a bias current is passed through the MR sensor. Magnetic flux emanating from a surface of the disk causes rotation of a magnetic moment of a sensing or ferromagnetic free layer of the MR sensor, which in turn causes the change in electrical resistance of the MR sensor. Since a voltage across the MR sensor is equal to the bias current that is supplied times the resistance, the change in electrical resistance of the MR sensor can be detected by measuring the voltage across the MR sensor to provide voltage information that external circuitry can then convert and manipulate as necessary.

When the MR sensor is configured as a spin valve sensor, the MR sensor includes a nonmagnetic electrically conductive spacer layer sandwiched between a ferromagnetic pinned layer and the ferromagnetic free layer. An antiferromagnetic (AFM) pinning layer interfaces the pinned layer for pinning the magnetic moment of the pinned layer 90° to an air bearing surface (ABS) of the sensor facing the disk. In response to positive and negative magnetic signal fields from the disk, the magnetic moment of the free layer rotates upwardly and downwardly with respect to the ABS from a zero bias point where the magnetic moment of the free layer is generally parallel to the ABS. Changes in resistance of the spin valve sensor is a function of cos θ, where θ is the angle between the magnetic moments of the pinned and free layers.

The magnetic moment of the pinned layer can also be rotated in the presence of some magnetic fields. Ability of the magnetic moment of the pinned layer to return to the original pinned direction when the magnetic field is relaxed is based on the remanence of the pinned layer since remanence is defined as magnetic induction that remains in a magnetic circuit after the removal of an applied magnetizing force. The return of the magnetic moment orientation of the pinned layer to the original pinned direction affects response of the MR sensor since the resistance is a function of the angle between the magnetic moments of the pinned and free layers. Additionally, remanence of the pinned layer contributes to the overall remanence of the MR sensor.

Desirably, the remanence of the pinned layer and/or the MR sensor is as low as possible to achieve a higher signal to noise ratio, magnetic stability and robustness. Further, difficulty in resetting the MR sensor increases with increased remanence of the pinned layer. However, MR sensors with, for example, platinum manganese (PtMn) as the AFM pinning layer provide a high remanence due to a large coercivity of the pinned layer that gets deposited on the PtMn. Accordingly, it is desirable to reduce the coercivity, and hence the remanence, of the pinned layer.

One method of reducing the coercivity of the pinned layer includes changing a cobalt iron (CoFe) composition of the pinned layer. However, this change of the CoFe composition provides a direct impact on pinned layer magnetostriction, which can cause mechanical stress within the MR sensor originated by overcoats and undercoats. Another method of reducing the remanence of the pinned layer involves substituting a different AFM material, which is typically not a viable option since qualification of any new material requires a lengthy process that includes understanding corrosion, chemical reactivity and magnetics. Other approaches to reduce the remanence of the pinned layer can undesirably alter the thermal stability of the MR sensor and/or reduce amplitude of the signal from the MR sensor.

Therefore, there exists a need for methods and MR sensors that provide improved remanence of a pinned layer, preferably without substantially altering other physical or magnetic properties within the MR sensors.

### SUMMARY OF THE INVENTION

According to one embodiment, a method of forming an exchange coupling layer of a magnetoresistive sensor includes depositing a ferromagnetic pinned layer structure that has a magnetic moment and depositing an antiferromagnetic (AFM) layer exchange coupled to the pinned layer structure for pinning the magnetic moment of the pinned layer structure. Depositing the AFM layer includes sputter depositing an AFM material in an atmosphere of a sputtering gas within a chamber. Selecting a flow rate for the sputtering gas into the chamber can obtain a desired remanence of the ferromagnetic pinned layer structure.

In another embodiment, a method of forming a magnetic head having an exchange coupling layer includes depositing a ferromagnetic pinned layer structure that has a magnetic moment and sputter depositing an antiferromagnetic (AFM) layer exchange coupled to the pinned layer structure for pinning the magnetic moment of the pinned layer structure. The sputter depositing can be performed according to a process where a flow rate of a sputtering gas into a deposition chamber is specifically selected to provide a desired remanence of the ferromagnetic pinned layer structure. The method can additionally include forming a free layer structure and forming a nonmagnetic spacer layer between the free layer structure and the pinned layer structure.

For yet another embodiment, a method of lowering remanence in a magnetic head includes depositing a ferromagnetic pinned layer structure that has a magnetic moment and lowering an initially established remanence of the ferromagnetic pinned layer structure by sputter depositing a platinum manganese (PtMn) layer exchange coupled to the pinned layer structure for pinning the magnetic moment of the pinned layer structure. The sputter depositing can be performed according to a process where a flow rate of argon into a deposition chamber is specifically selected to provide a desired remanence of the ferromagnetic pinned layer structure that is lower than the initially established remanence

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top plan view of a hard disk drive including a magnetic head, according to embodiments of the invention.

FIG. 2 is a diagrammatic air bearing surface view of a magnetoresistive (MR) stack within the magnetic head, according to embodiments of the invention.

FIG. 3 is a hysteresis curve for a MR sensor showing resistance of the MR sensor verses a magnetic field applied to the MR sensor, the MR sensor configured according to embodiments of the invention.

FIG. 4 is a plot of a low field remanence percentage (RemL), which is inversely proportional to remanence, verses a thickness of a nickel iron chromium (NiFeCr) seed layer.

FIG. 5 is a plot of MR coefficient verses the thickness of the NiFeCr seed layer.

FIG. 6 is a plot of RemL verses a thickness of a nickel iron (NiFe) seed layer.

FIG. 7 is a plot of MR coefficient verses the thickness of the NiFe seed layer.

FIG. 8 is a plot of RemL verses a flow rate of argon while depositing platinum manganese (PtMn) to form an antiferromagnetic layer.

FIG. 9 is a flow chart of a method of forming a magnetic head having an exchange coupling layer, according to embodiments of the invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

Embodiments of the invention generally relate to controlling remanence of a pinned layer within a magnetoresistive (MR) sensor. The remanence of the pinned layer can initially be set based at least in part on desired compositions and thicknesses of the pinned layer, an anitferromagnetic pinning layer and any intervening seed layers to provide the MR sensor with desired properties, such as signal response and mechanical characteristics. Adjusting a flow rate of an inert gas such as argon (Ar) during deposition of the anitferromagnetic pinning layer can control the remanence of the pinned layer without altering the desired compositions and thicknesses in substantially any other way. Further, the remanence of the pinned layer can be improved by adjusting the flow rate of the argon without any substantial change in configuration or texture of the antiferromagnetic pinning layer or the MR sensor overall.

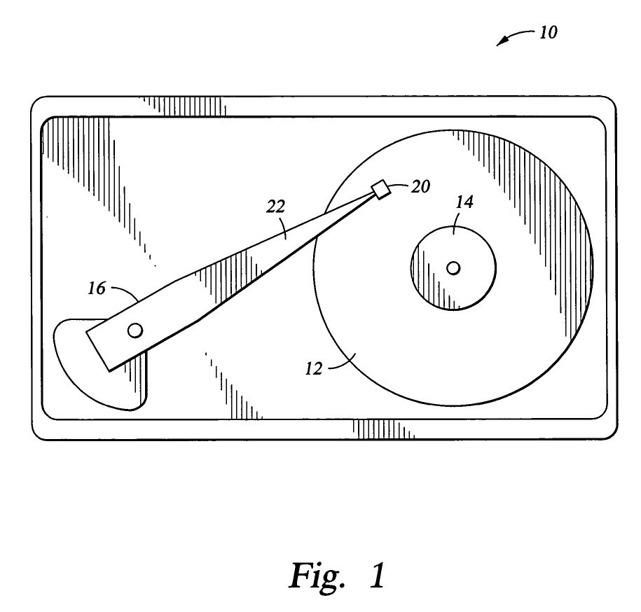

FIG. 1 illustrates a hard disk drive 10 that includes a magnetic media hard disk 12 mounted upon a motorized spindle 14. An actuator arm 16 is pivotally mounted within the hard disk drive 10 with a magnetic head 20 disposed upon a distal end 22 of the actuator arm 16. During operation of the hard disk drive 10, the hard disk 12 rotates upon the spindle 14 and the magnetic head 20 acts as an air bearing slider adapted for flying above the surface of the disk 12. As described hereinafter, the magnetic head 20 includes a substrate base upon which various layers and structures that form the magnetic head 20 are fabricated. Thus, magnetic heads disclosed herein can be fabricated in large quantities upon a substrate and subsequently sliced into discrete magnetic heads for use in devices such as the hard drive 10.

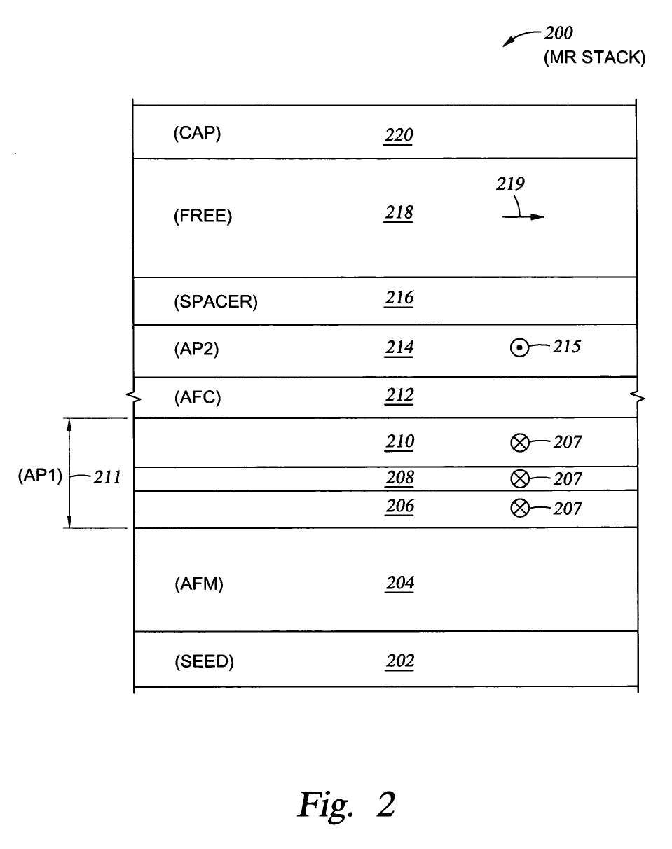

FIG. 2 illustrates a diagrammatic bottom view of a MR stack 200 within the magnetic head 20. As an exemplary MR sensor configuration for incorporating embodiments of the invention, the MR stack 200 includes an initial seed layer 202, an antiferromagnetic (AFM) layer 204, a first pinned layer (AP1) 211, an antiferromagnetic coupling (AFC) layer 212, a second pinned layer (AP2) 214, a spacer layer 216, a free layer 218, and a cap 220. The initial seed layer 202 can be a tantalum (Ta) layer for depositing the AFM layer 204 on. The AFC coupling layer 212, such as ruthenium (Ru), separates the first and second pinned layers 211, 214 disposed above the AFM layer 204. Additionally, the AFM layer 204 can be composed of platinum manganese (PtMn) and can be exchange coupled to the first pinned layer 211 for pinning a magnetic moment 207 of the first pinned layer 211 in a direction either out of the head or into the head.

The first pinned layer 211 disposed on the AFM layer 204 can include a nickel iron chromium (NiFeCr) seed layer 206, a nickel iron (NiFe) seed layer 208 and a cobalt iron (CoFe) layer 210. Due to a strong antiparallel coupling between the magnetic moment 207 of the first pinned layer 211 and a magnetic moment 215 of the second pinned layer 214, the direction of the magnetic moments 207, 215 of the pinned layers 211, 214 are antiparallel.

The spacer layer 216 composed of, for example, copper (Cu) separates the second pinned layer 214 from the free layer 218. Further, a cap 220, such as Ta, disposed on the free layer 218 completes the MR stack 200. The free layer 218 provides a magnetic moment 219 directed from right to left or from left to right. When a field signal from the disk 12 (shown in FIG. 1) rotates the magnetic moment 219 into the head, the magnetic moments 215 and 219 become more antiparallel increasing the resistance of the MR stack 200 to applied current. Alternatively, the magnetic moments 215 and 219 become more parallel to decrease the resistance of the MR stack 200 when the field signal rotates the magnetic moment 219 out of the head. These resistance changes cause potential changes that are processed as playback signals. The resistance and remanence of the MR stack 200 through a range of applied magnetic fields can be analyzed using a hysteresis of the MR stack.

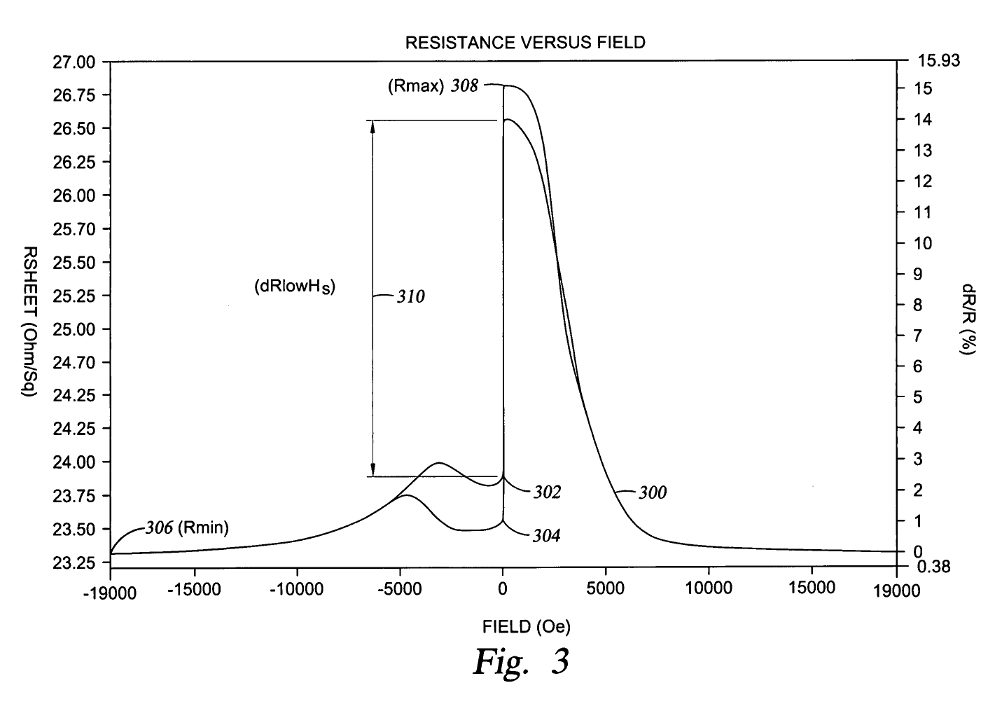

FIG. 3 shows a hysteresis curve 300 for a MR sensor by plotting resistance of the MR sensor along the y-axis verses a magnetic field applied to the MR sensor. As indicated on the x-axis, the magnetic field is applied from −19,000 oersted (Oe) to 19,000 Oe. Additionally, a left side of the plot along the y-axis indicates a sensitivity of the MR sensor based on a maximum value of 15.1%. The maximum value of 15.1% denotes a MR coefficient (dr/R) that quantifies the sensitivity, where dr is the change in the resistance of the MR sensor as the magnetic moment of a free layer rotates from a position parallel with respect to the magnetic moment of a pinned layer to an antiparallel position with respect thereto and R is the resistance of the MR sensor when the magnetic moments are parallel. Graphically using a minimum resistance (Rmin) point 306 and a maximum resistance (Rmax) point 308, dr/R represents (Rmax−Rmin)/Rmin.

The hysteresis curve 300 also indicates the remanence of the MR sensor as evidenced by separation of a first point 302 from a second point 304 along the hysteresis curve 300 where the magnetic field is zero. In other words, the resistance with no magnetic field applied is not the same at the two points, depending on the remanence such as contributed by the pinned layer. Depending on whether the applied magnetic field is decreasing or increasing, the magnetic moment of, for example, the pinned layer can be subject to magnetic induction that remains once the applied magnetic field is removed such that this magnetic induction influences the magnetic moment of the pinned layer and hence the resistance of the MR sensor.

To provide an inverse quantification of the remanence, a low field remanence percentage (RemL) is calculated utilizing a differential 310 known as dRlowHs. The formula dRlowHs/(Rmax−Rmin) defines the low field remanence percentage. Accordingly, the remanence of the MR sensor decreases as the low field remanence percentage or RemL increases. Various approaches exist to desirably increase the RemL indicating a decrease in the remanence.

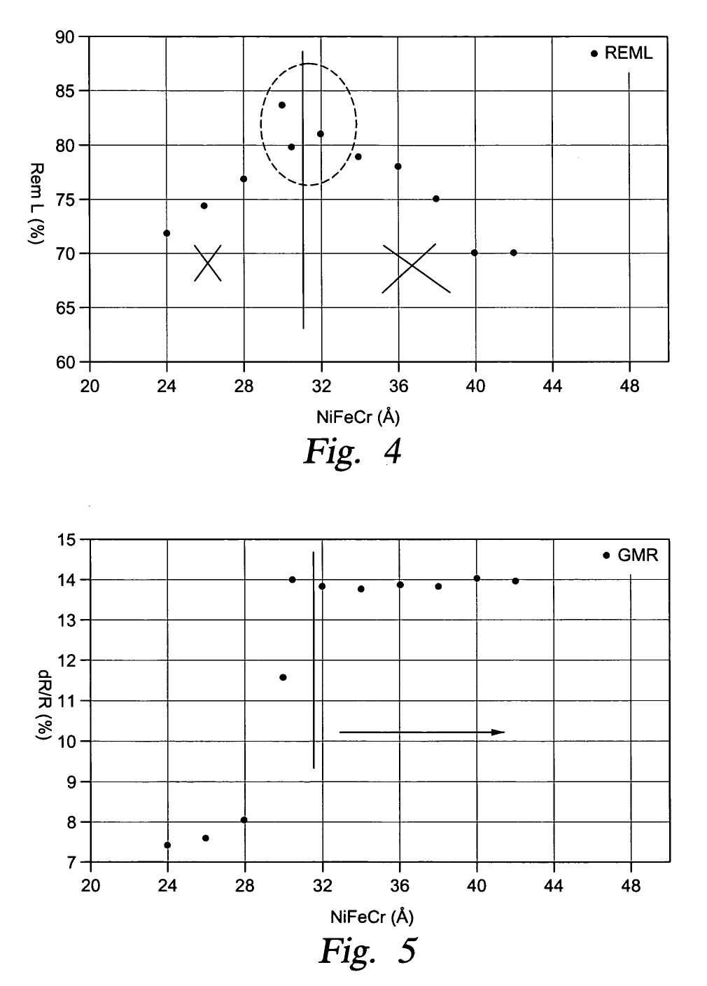

FIG. 4 illustrates a plot of RemL verses a thickness of a NiFeCr seed layer, such as the NiFeCr seed layer 206 shown in FIG. 2. Varying the thickness of the NiFeCr seed layer changes the RemL. The thickness of the NiFeCr seed layer at about 30 angstroms (Å) provides maximum values for the RemL. As the thickness of the NiFeCr seed layer is increased or decreased from a range around 30 Å, the remanence can become too high and/or the MR coefficient can be too low.

FIG. 5 shows a plot of MR coefficient verses the thickness of the NiFeCr seed layer. In order to provide a sufficient MR coefficient, the NiFeCr seed layer must be about 30 Å thick or larger. Consequently, ability to vary the thickness of the NiFeCr seed layer to adjust remanence is limited by the thickness creating too much loss in the MR coefficient. Further, varying the thickness of the NiFeCr seed layer from a previously selected desired thickness can be harsh on the MR sensor due to creation of thermal stability problems where head noise increases with higher temperatures. Additionally, coercivity of the free layer can undesirably increase as the thickness of the NiFeCr seed layer is enlarged.

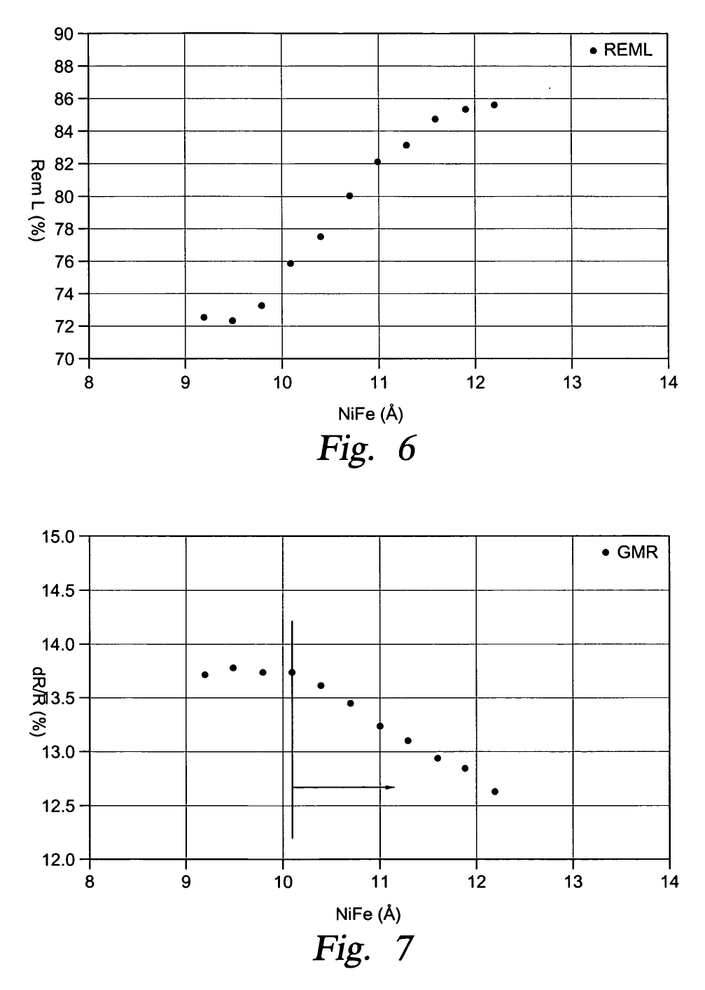

FIG. 6 illustrates a plot of RemL verses a thickness of a NiFe seed layer, such as the NiFe seed layer 208 shown in FIG. 2. Varying the thickness of the NiFe seed layer also changes the RemL. Generally, the RemL increases as the thickness of the NiFe seed layer is increased from about 9 Å to about 12 Å. Like the NiFeCr seed layer, the thickness of the NiFe seed layer is typically established to provide a desired MR coefficient and/or other properties of the MR sensor such that tuning or controlling the remanence by varying the thickness of the NiFe seed layer is not an available option.

In this regard, FIG. 7 shows a plot of MR coefficient verses the thickness of the NiFe seed layer. In order to provide a sufficient MR coefficient, the NiFe seed layer must be less than about 10 Å. Thus, ability to vary the thickness of the NiFe seed layer to adjust remanence is again limited by the thickness creating too much loss in the MR coefficient.

An AFM layer that is adjacent a pinned layer can also affect the remanence of the pinned layer. In forming a MR sensor, depositing a layer of PtMn via sputtering can provide the AFM layer. In operation, the sputtering can be a radio frequency (RF) sputtering process that provides a physical vapor deposition (PVD) technique within a chamber wherein atoms or molecules are ejected from a target material of PtMn by generating ions directed at the target material to sputter atoms from the target. These sputtered atoms get transported in the chamber to a substrate through a region of reduced pressure for condensing on the substrate and forming the AFM layer. Therefore, a flow rate of a sputtering gas such as Ar into the chamber during the sputtering can be used to manipulate conditions of the sputtering by altering the number of argon ions present and the argon pressure within the chamber.

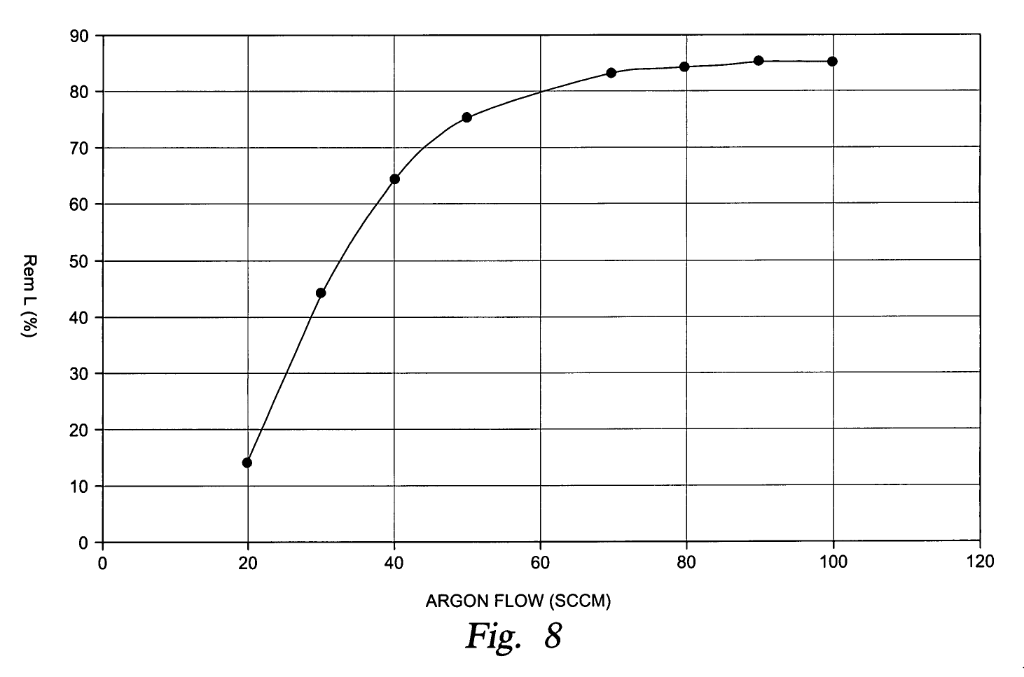

FIG. 8 illustrates a plot of RemL verses the flow rate of Ar while depositing PtMn to form the AFM layer. In a chamber having a volume of about 0.058 cubic meters (m³), changing the flow rate of Ar from 20 standard cubic centimeters per minute (sccm) to 100 sccm increases the RemL, which is indicative of lower remanence. The increase in the flow rate of Ar into the chamber during the sputtering raises the pressure within the chamber during sputtering and adds to the number of argon ions present in the chamber. This direct impact on the remanence of the pinned layer due to the flow rate of Ar enables controlling the remanence during manufacturing of the MR sensor. Referring to FIG. 3, the hysteresis curve 300 represents the MR sensor manufactured by selecting the flow rate of Ar to be 70 sccm while sputter depositing PtMn to form the AFM layer within the MR sensor. This selection of the flow rate of Ar provides the RemL with a value of about 77.35%.

Adjusting the flow rate of Ar does not require altering a thickness of the AFM layer that is deposited by the sputtering and substantially does not change a physical texture of the AFM layer. A threshold minimum for the flow rate of Ar can be based on an acceptable upper limit for the remanence. Additionally, a threshold maximum for the flow rate of Ar can be determined even though the RemL can continue to increase when the flow rate of Ar is greater than the threshold maximum. The flow rate of Ar above the threshold maximum can change the platinum to manganese ratio causing an excess concentration of manganese in the AFM layer. The excess concentration of manganese can degrade magnetics of the AFM layer preventing proper exchange coupling with the pinned layer. Based on the foregoing, the flow rate of Ar can be manipulated within a range of, for example, about 40 sccm to about 80 sccm to control the remanence of the pinned layer, according to one embodiment.

With reference to FIG. 2, manipulating the remanence of the first pinned layer 211, for some embodiments, includes selecting the NiFeCr and NiFe seed layers 206, 208 to have a desired thickness as described herein. Further, the flow rate of Ar during deposition of the AFM layer 204 can be controlled to tune the remanence of the first pinned layer 211 initially to be provided, given the previously selected thicknesses for the NiFeCr and NiFe seed layers 206, 208. Accordingly, the remanence of the first pinned layer 211 can be adjusted without deviating from the previously selected compositions and thicknesses for the NiFeCr and NiFe seed layers 206, 208 or composition of the CoFe layer 210. Further, changing the remanence of the first pinned layer 211 by controlling the flow rate of Ar during deposition of the AFM layer 204 does not require that the AFM layer 204 be made of different materials where it is desired for the AFM layer 204 to be composed of PtMn.

The remanence of the first pinned layer 211 can initially be set based at least in part on desired compositions and thicknesses of the pinned layer 211 and the AFM layer 204 to provide the MR stack 200 with satisfactory magnetic and mechanical properties. Selecting the flow rate of Ar during deposition of the AFM layer 204 can improve the remanence of the first pinned layer 211. Accordingly, the remanence of the first pinned layer 211 can be improved during manufacture of the MR stack 200 by adjusting the flow rate of Ar without any substantial change in configuration or texture of the MR stack 200.

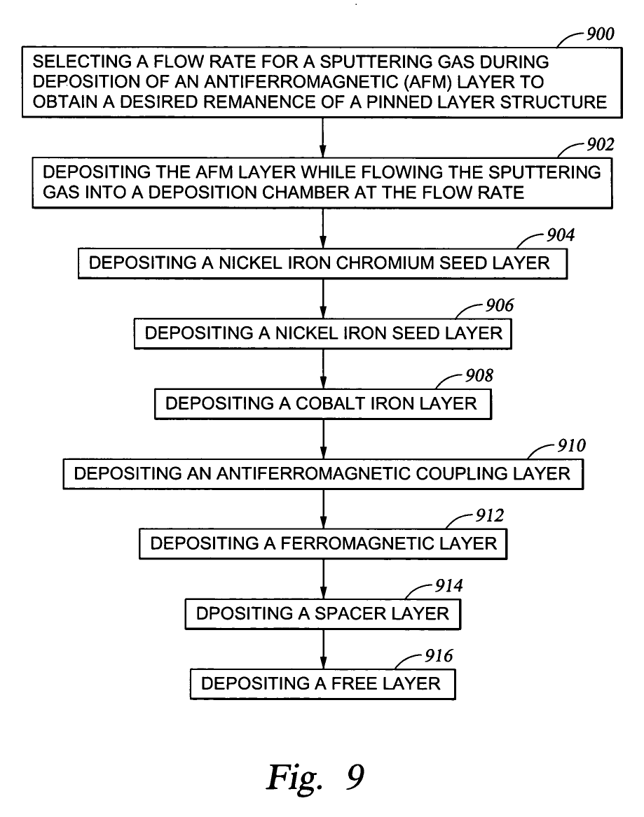

Based on the foregoing, FIG. 9 shows a flow chart of a method of forming a magnetic head having an exchange coupling layer. At step 900, selecting a flow rate for a sputtering gas during deposition of an AFM layer obtains a desired remanence of a pinned layer structure. For some embodiments, the flow rate of the sputtering gas, e.g., Ar, per cubic meter of a deposition chamber can be selected to be between 690 standard cubic centimeters per minute (sccm) and 1380 sccm. Next, depositing the AFM layer, e.g., PtMn, to be exchange coupled to the pinned layer structure for pinning the magnetic moment of the pinned layer structure occurs at step 902 while flowing the sputtering gas into the chamber at the flow rate that is selected. Depositing the ferromagnetic pinned layer structure can include depositing a NiFeCr seed layer at step 904, a NiFe seed layer at step 906 and a CoFe layer at step 908. For some embodiments, the NiFeCr seed layer has a thickness of about 30.0 Å and the NiFe seed layer has a thickness of about 10 Å. Forming the magnetic head can further include depositing an AFC layer at step 910, depositing a ferromagnetic layer at step 912 to provide another pinned layer, depositing a nonmagnetic spacer layer at step 914, and depositing a free layer structure at step 916.

While the foregoing is directed to embodiments of the present invention, other and further embodiments of the invention may be devised without departing from the basic scope thereof, and the scope thereof is determined by the claims that follow.

What is claimed is:

1. A method of forming an exchange coupling layer of a magnetoresistive sensor, comprising:
depositing a ferromagnetic pinned layer structure that has a magnetic moment;
depositing an antiferromagnetic (AFM) layer exchange coupled to the pinned layer structure for pinning the magnetic moment of the pinned layer structure, wherein depositing the AFM layer includes sputter depositing an AFM material in an atmosphere of a sputtering gas within a chamber; and
selecting a flow rate for the sputtering gas into the chamber to obtain a desired remanence of the ferromagnetic pinned layer structure.

2. The method of claim 1, wherein the flow rate that is selected is previously obtained by tuning the flow rate of the sputtering gas under defined process conditions for a given thickness of one or more seed layers of the sensor.

3. The method of claim 1, wherein the sputtering gas comprises argon.

4. The method of claim 3, wherein the AFM material comprises platinum and manganese.

5. The method of claim 4, wherein depositing the ferromagnetic pinned layer structure includes depositing a nickel iron chromium (NiFeCr) seed layer, a nickel iron (NiFe) seed layer, and a cobalt iron (CoFe) layer.

6. The method of claim 4, wherein the flow rate of the sputtering gas per cubic meter of the chamber is selected to be between 690 standard cubic centimeters per minute (sccm) and 1380 sccm.

7. The method of claim 1, wherein the AFM material comes from a target of platinum manganese (PtMn).

8. The method of claim 1, wherein the sputtering gas is an inert gas.

9. The method of claim 1, wherein depositing the ferromagnetic pinned layer structure includes depositing a nickel iron chromium (NiFeCr) seed layer, a nickel iron (NiFe) seed layer and a cobalt iron (CoFe) layer.

10. The method of claim 9, wherein the NiFeCr seed layer has a thickness of about 30.0 angstroms (A) and the NiFe seed layer has a thickness of about 10 Å.

11. The method of claim 1, wherein the flow rate of the sputtering gas per cubic meter of the chamber is selected to be between 690 standard cubic centimeters per minute (sccm) and 1380 sccm.

12. The method of claim 1, wherein selecting the flow rate for the sputtering gas to obtain the desired remanence includes adjusting an initially established remanence of the ferromagnetic pinned layer structure based on a preset configuration of the ferromagnetic pinned layer structure and a preset composition of the AFM layer.

13. A method of forming a magnetic head having an exchange coupling layer, comprising:
depositing a ferromagnetic pinned layer structure that has a magnetic moment;
sputter depositing an antiferromagnetic (AFM) layer exchange coupled to the pinned layer structure for pinning the magnetic moment of the pinned layer structure, wherein the sputter depositing is performed according to a process where a flow rate of a sputtering gas into a deposition chamber is specifically selected to provide a desired remanence of the ferromagnetic pinned layer structure;
forming a free layer structure; and
forming a nonmagnetic spacer layer between the free layer structure and the pinned layer structure.

14. The method of claim 13, wherein the sputtering gas comprises argon.

15. The method of claim 13, wherein the AFM layer comprises platinum and manganese.

16. The method of claim 13, wherein depositing the ferromagnetic pinned layer structure includes depositing a nickel iron chromium (NiFeCr) seed layer, a nickel iron (NiFe) seed layer, and a cobalt iron (CoFe) layer.

17. The method of claim 13, wherein the seed layers each have a preset thickness contributing to an initially established remanence of the ferromagnetic pinned layer that is adjusted to the desired remanence by the sputter depositing.

18. A method of lowering remanence in a magnetic head, comprising:
depositing a ferromagnetic pinned layer structure that has a magnetic moment; and
lowering an initially established remanence of the ferromagnetic pinned layer structure by sputter depositing a platinum manganese (PtMn) layer exchange coupled to the pinned layer structure for pinning the magnetic moment of the pinned layer structure, wherein the sputter depositing is performed according to a process where a flow rate of argon into a deposition chamber is specifically selected to provide a desired remanence of the ferromagnetic pinned layer structure that is lower than the initially established remanence.

19. The method of claim 18, wherein the flow rate of the argon per cubic meter of the deposition chamber is selected to be between 690 standard cubic centimeters per minute (sccm) and 1380 sccm.

20. The method of claim 18, wherein depositing the ferromagnetic pinned layer structure includes depositing a nickel iron chromium (NiFeCr) seed layer, a nickel iron (NiFe) seed layer and a cobalt iron (CoFe) layer.

21. The method of claim 20, wherein the seed layers each have a preset thickness contributing to the initially established remanence.
